(19) United States
(12) Patent Application Publication
(10) Pub. No.: US 2011/0016957 A1
(43) Pub. Date: Jan. 27, 2011

(54) METHOD AND SYSTEM FOR MONITORING PROPER CONNECTION BETWEEN A VALVE/SEPARATOR AND AN INTAKE SYSTEM WITHIN A CCV SYSTEM

(76) Inventors: Ted Haladyna, Northville, MI (US); Christopher Oberski, Plymouth, MI (US); Brien Lloyd Fulton, West Bloomfield, MI (US); Roberto Teran, JR., Livonia, MI (US); Michelle M. Hutchison, Canton, MI (US); Michiel J. Van Nieuwstadt, Ann Arbor, MI (US); John Paul Bogema, Flat Rock, MI (US)

Correspondence Address: RICHARD M. SHARKANSKY, 114 TIDE RUN, MASHPEE, MA, 02649, US

(21) Appl. No.: 12/508,625

(22) Filed: Jul. 24, 2009

(51) Int. Cl. G01M 15/04

(52) U.S. Cl. 73/114.31

(57) ABSTRACT

A method and system for monitoring proper connection between a valve/separator and an intake system through a crankcase ventilation system. A dielectric hose has an electrically hose conductive connector mechanically connectable to either: (a) an electrically conductive valve/separator connector, or (b) an electrically conductive intake system connector. An electrical circuit detects electrical continuity through the hose connector and the one of the valve/separator connector or the intake system connector mechanically connectable to said hose connector.

### TECHNICAL FIELD

This disclosure relates generally to crankcase ventilation (CCV) systems and more particularly to methods and systems for monitoring proper connection of a crankcase ventilation system between a valve cover and an engine intake system through a CCV system.

### BACKGROUND AND SUMMARY

As is known in the art, crankcase ventilation systems (CCVs) have long been used to remove crankcases gases from the crankcase of an engine. Crankcases gases are a combination of (i) blow-by gases, (i.e., combusted and non-combusted combustion chamber gases which migrate past piston rings into the crankcase), (ii) fuel, (iii) air, and (iv) oil vapor. CCVs regulate the removal of crankcase gases from the crankcase by venting the gases into the engine intake system. The gases may pass to the intake system through a hose or tube having one end connected to the intake system of the engine and the other end connected to either: an oil separator, in the case of a diesel engine, or a valve, such as, for example a PCV, in the case of a gasoline engine. Herein, the term valve/separator is used to include both the valve as used in a gasoline engine and oil separators as used in diesel engines. The inlet to the engine intake system can be positioned anywhere from the air filter outlet up to, and including the intake manifold of the engine. The removal of crankcases gases from the crankcase improves oil life, quality and durability which in turn improve engine life, quality and durability.

As is also known in the art, California Air Recourses Board (CARB) On-Board diagnostic regulations require monitoring of the connections of the ventilation tube from the crank case ventilation system to the intake system. Several methods exist for these monitors that have various levels of robustness and cost. These methods include utilizing air system sensors and predictive models to detect the equivalent of an air leak in the intake system; and the use of a pressure sensor in the crank case ventilation system itself to detect the intake system pressure change when a disconnection has occurred.

In accordance with the present disclosure, a method is provided for monitoring proper connection of the crankcase ventilation system between a valve/separator and intake system. The method includes detecting electrical continuity through a hose connector at an end of a hose and either a valve/separator connector or an intake system connector mechanically connectable to the hose connector.

In one embodiment, a method is provided for monitoring of a proper connection in a path between a valve/separator and an intake system. The method includes: detecting electrical continuity through mechanical hose connectors and: (a) a valve/separator connector mechanically connectable to one of the hose connectors; and (b) an intake system connector mechanically connectable to the other end of the hose.

In one embodiment, a system is provided for monitoring proper connection between a valve/separator and an intake system through a crankcase ventilation valve/separator. The system includes: an dielectric (i.e., non-electrically conducting) hose having an electrically conductive connector mechanically connectable to either: (a) an electrically conductive valve/separator connector, or (b) an electrically conductive intake system connector; and an electrical circuit for detecting electrical continuity through the hose connector and one of the valve/separator connector or intake system connector mechanically connectable to said hose connector.

In one embodiment, the circuit includes a voltage source; and a current limiting device connected between the voltage source and one of the valve/separator connector or the intake system connector.

In one embodiment, a system is provided for monitoring proper connection between a valve/separator and an intake system through a crankcase ventilation valve/separator. The system includes: a dielectric hose having a first electrically conductive connector mechanically connectable to an electrically conductive valve/separator connector and a second electrically conductive connector mechanically connectable to an electrically conductive intake system connector; and an electrical circuit for detecting electrical continuity through the first connector and the valve/separator connector and between the second connector and the intake system connector.

This method and system provide a simple circuit to the Crank Case Vent tube and if the tube is connected properly will result in closing a circuit. If the tube is not connected properly, the circuit will be open. Over the air mass solution this monitor is more robust and not influenced by noise factors of other system leaks, air meter drift or system pressure transducer changes, engine volumetric efficiency differences between engines. Over the pressure sensor in the crankcase, this system is more robust (not subject to the noise factors of crank pressure drift and system operation) and is much less costly (simple continuity circuits are a fraction of sensor, wiring, connector and sensor circuit costs).

The details of one or more embodiments of the disclosure are set forth in the accompanying drawings and the description below. Other features, objects, and advantages of the disclosure will be apparent from the description and drawings, and from the claims.

### DESCRIPTION OF DRAWINGS

FIG. 1 is a diagram of an internal combustion engine having system for monitoring proper connection between a valve/separator and an intake system of the engine according to the disclosure; and

FIG. 2 is a diagram of system for monitoring proper connection on both connections between a valve/separator and an intake system using a single continuity circuit of FIG. 1 according to the disclosure; and

FIG. 3 is a diagram of system which when used to identify which one of a pair of connections in the system is improper according to the disclosure.

Like reference symbols in the various drawings indicate like elements.

### DETAILED DESCRIPTION

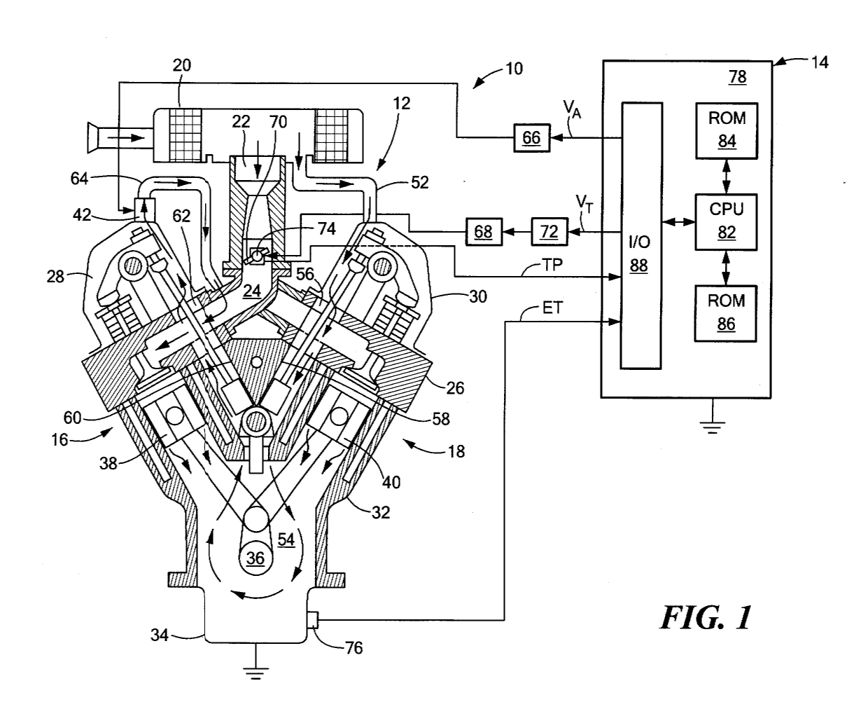

Referring to FIG. 1 an automotive vehicle 10 includes an internal combustion engine 12 and an engine control system 14. The Engine 12 may include a plurality of cylinders in cylinder banks 16, 18. Engine 12 may further include an air filter 20, a throttle body 22, an intake system 24, an engine head 26, cam or covers 28, 30, an engine block 32, an oil pan 34, a crankshaft 36, pistons 38, 40, a crankcase ventilation valve/separator 42, and exhaust aftertreatment elements, not shown.

Engine 12 inducts air through filter 20 into the intake system that includes both throttle body 22 and can include a conduit or passage 52. The air inducted into throttle body 22 is routed past throttle plate 70 to intake manifold 24. Thereafter, the air is inducted into the engine cylinders where an air-fuel mixture is combusted. During or after a combustion cycle, a portion of the gases in cylinder banks 16, 18 hereinafter referred to as crankcase gases; migrate past pistons 38, 40 into an engine crankcase 54. As discussed above, these crankcase gases can mix with the oil in crankcase 54 to reduce oil quality that can degrade the performance of the engine 12.

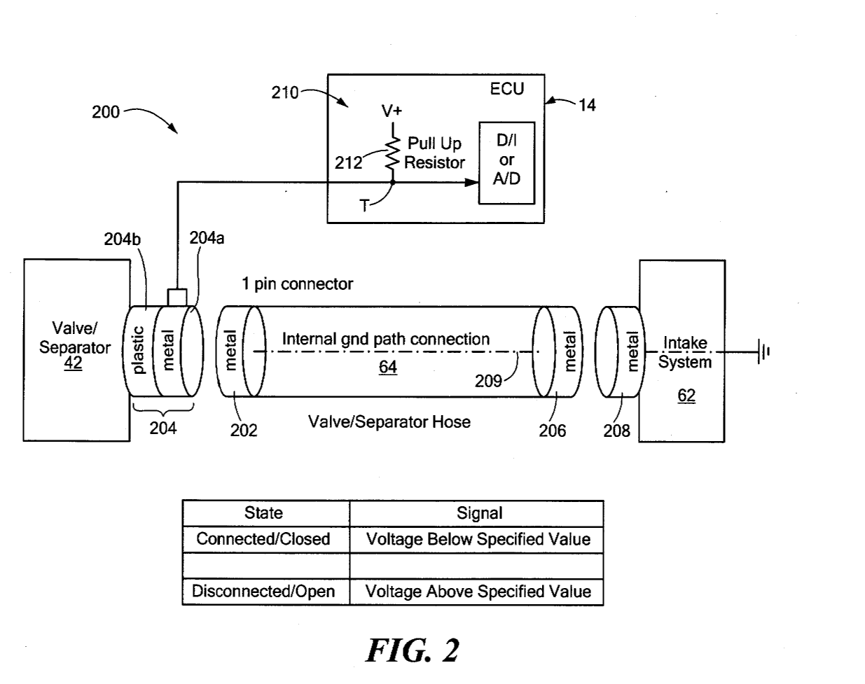

The diluted crankcase gases flow through conduit 60 (in engine block 32) and conduit 62 (in engine head 26) to cam cover 28. From cam cover 28, valve/separator 42 is used to control flow of the crankcase gases into intake system 24. As illustrated, a portion of valve/separator assembly extends through a top surface of cam cover 28 to control the flow of crankcase gases into intake system 24. In particular, the gases flow through the valve/separator assembly and through conduit or tube 64 to intake system 24. Thereafter, the crankcase gases mix with incoming air and are inducted into the engine cylinders. The crankcase gases and other combusted gases flow from the engine cylinders to exhaust aftertreatment elements, not shown, which is used to oxidize carbon monoxide (CO), hydrocarbons (HC), and particulate matter (PM) and to reduce nitrogen oxides (NOx). The tube 64 and its connection at one end to the CCV 42 and at the other end to the intake system 24 is shown in more detail in FIG. 2.

Electric motor 68 is provided to move throttle plate 70 to a predetermined position responsive to a current received from ETC driver 72. ETC driver 72 generates the current responsive to a control signal (VT) from controller 78.

Throttle position sensor 74 generates a signal (TP) indicating a throttle position of throttle plate 70 received by controller 78 for closed-loop position control of plate 70.

Temperature sensor 76 generates a signal (ET) indicative of an oil temperature that is received by controller 78. Sensor 76 may be coupled to oil pan 34. Alternately, sensor 76 could measure an engine coolant temperature (ECT), an engine block temperature, or any other temperature indicative of an operating condition of engine 12.

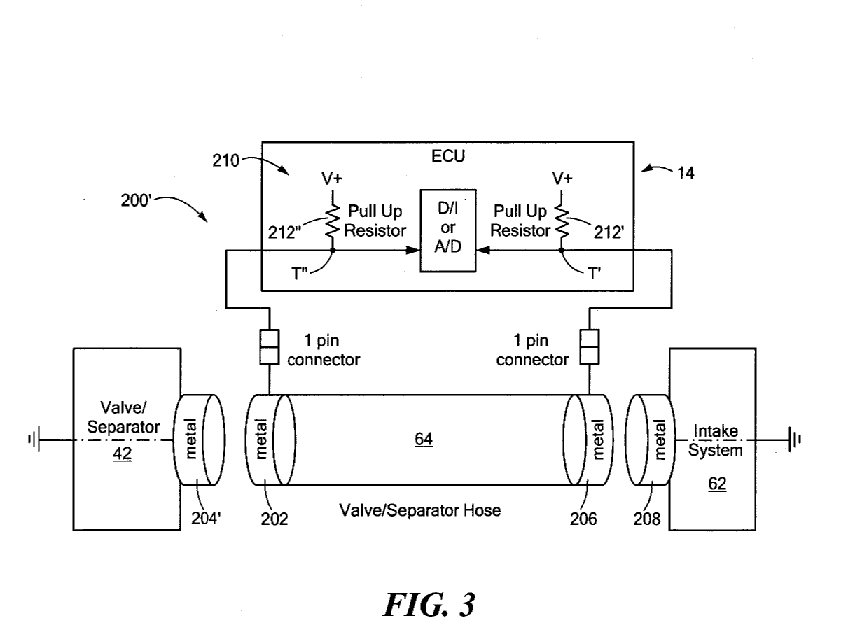

It should be understood that while a gasoline engine has been described in FIG. 1, the systems for monitoring proper connection of a crankcase ventilation system between a valve/separator and an intake system as described in more detail in FIGS. 2-4 below may be used in a diesel engine where the engine is controlled by using fuel demand from the fuel pump as opposed to the throttle plate.

An engine control system 14 is provided to control operation of engine 12. Controller 78 includes a microprocessor 82 communicating with various computer-readable storage media. The computer readable storage media preferably include nonvolatile and volatile storage in a read-only memory (ROM) 84 and a random-access memory (RAM) 86. The computer readable media may be implemented using any of a number of known memory devices such as PROMs, EPROMs, EEPROMs, flash memory or any other electric, magnetic, optical or combination memory device capable of storing data, some of which represent executable instructions, used by microprocessor 82 in controlling engine 12. Microprocessor 82 communicates with various sensors and actuators (discussed above) via an input/output (I/O) interface 88.

Referring now to FIG. 2, a system 200 is shown for monitoring proper connection between the valve/separator 42 and an intake system 24 through the crankcase ventilation valve/separator 42. The system 200 includes tube 64, here a plastic or other electrically insulating (i.e., dielectric) material, having an electrically hose conductive connector 202 at one end mechanically connectable to an electrically conductive portion 204a of the CCV connector 204, the housing of the valve/separator 42 being electrically insulated from the electrically conductive portion 204a of the valve/separator connector 204 through an electrically insulating (i.e., dielectric), here plastic portion 204b of the valve/separator connector 204 and an electrically hose conductive connector 206 at the other end mechanically connectable to an electrically conductive intake system connector 208, as shown. A conductive wire 209 passes though the tube 64 to electrically connect the connectors 202 and 206 at the ends of the tube 64, as shown. The system 200 includes an electrical circuit 210 for detecting electrical continuity through the hose connector 202 and the valve/separator connector 204 and for detecting electrical continuity through the hose connector 206 and the intake system connector 208.

Here, the circuit 200 includes a voltage sources +V; and a current limiting, or pull up, device 212 connected between the voltage source +V and one of the valve/separator connectors 204, or 206, here connector 204 and the intake system connector 208, it being noted that the intake system 62 is grounded. Here, the current limiting device is a resistor but other devices may be used, such as for example, diode connected FETs.

In operation, if there is a proper mechanical connection between both the hose connector 202 and the valve/separator connector 204 and between hose connector 206 and intake system connector 208 there is electrical continuity through the connectors 202, wire 209, and through the connectors 206, 208 to ground and current will pass from the voltage source +V, through the current limiting resistor 212 through the properly mechanically connected connectors 204, 202, 206 and 208 and then to ground thereby producing a low, or ground potential at the terminal T of the resistor. The potential at the terminal T of the resistor is fed as an input/output or analog/digital converter of the ECU 14 and such low or ground potential is interpreted by the ECU 14 as indicating proper mechanical connection between the connectors 204, 202, 206 and 208.

On the other hand, if there is an improper mechanical connection between either the hose connector 202 and the valve/separator connector 204 or between hose connector 206 and intake system connector 208, there will not be electrical continuity through the connectors 204, 202, 206 and 208 and current will not pass from the voltage source +V, through the current limiting resistor 212 through the connectors 204, 202, 206 and 208 and then to ground thereby producing a high, +V potential at resistor terminal T. This high potential is interpreted by the ECU 14 as indicating improper mechanical connection between the connectors 204, 202, 206 and 208.

It is noted that the circuit 200 will indicate an improper connection between either connector 204 and 202, or an improper connection between conductors 206 and 208.

If it is required to identify which one of the two possible mechanical connections is improper, a second circuit 200′ is used. Such circuit 200′ includes a pair of pull up resistors 212′, 212″ having terminal T′, T″, respectively, as shown thereof mechanically connected to connector 202, 206, respectively, as shown. It is noted that here there is no wire passing through the tube 64 as in the system 200 in FIG. 2. It is also noted that the valve/separator 42 is grounded and the connector at the valve/separator 42 is a metal connector 204′ (i.e., the insulator 204b in FIG. 2 is removed).

In operation, if there is a proper mechanical connection between connectors 202 and 204, the voltage at terminal T″ is low, i.e., ground, and if the is an improper connection between connectors 202 and 204, the voltage at terminal T″ is high, i.e., +V volts. In operation, if there is a proper mechanical connection between connectors 206 and 208, the voltage at terminal T′ is low, i.e., ground, and if the is an improper connection between connectors 206 and 208, the voltage at terminal T′ is high, i.e., +V volts.

A number of embodiments of the disclosure have been described. Nevertheless, it will be understood that various modifications may be made without departing from the spirit and scope of the disclosure. Accordingly, other embodiments are within the scope of the following claims.

1. A method for monitoring proper connection of a crankcase ventilation system between a valve/separator cover and an intake system comprising:
detecting electrical continuity through a hose connector at an end of a hose and either a valve/separator connector or an intake system connector mechanically connectable to the hose connector.

2. A method for monitoring proper connection of a crankcase ventilation system between a valve/separator cover and an intake system comprising:
detecting electrical continuity through mechanical hose connectors at ends of a hose and: (a) a valve/separator connector mechanically connectable to one of the hose connectors; and (b) an intake system connector mechanically connectable to the other one of the hose connectors.

3. A method for monitoring proper connection of a crankcase ventilation system between a valve/separator cover and an intake system comprising:
a dielectric hose having an electrically hose conductive connector mechanically connectable to either: (a) an electrically conductive valve/separator connector, or (b) an electrically conductive intake system connector;
an electrical circuit for detecting electrical continuity through the hose connector and the one of the valve/separator connector or intake system connector mechanically connectable to said hose connector.

4. The system recited in claim 3 wherein the circuit includes a voltage sources; and a current limiting device connected between the voltage source and one of the valve/separator connector or the intake system connector.

5. A method for monitoring proper connection of a crankcase ventilation system between a valve/separator cover and an intake system comprising:
a dielectric hose having a first electrically conductive connector mechanically connectable to an electrically conductive valve/separator connector and a second electrically conductive connector mechanically connectable to an electrically conductive intake system connector;
an electrical circuit for detecting electrical continuity through the first connector and the valve/separator connector and between the second connector and the intake system connector.

6. The system recited in claim 5 wherein the circuit includes a voltage sources; and a current limiting device connected between the voltage source and one of the valve/separator connector or the intake system connector.

7. The system recited in claim 6 wherein the current limiting device is a resistor.

8. The system recited in claim 5 including a second electrical circuit for detecting electrical continuity through the one of the hose connectors and the one of the valve/separator connector or intake system connector mechanically connectable to said one of the hose connectors.
